(19) United States
(12) Patent Application Publication
(10) Pub. No.: US 2015/0236906 A1
(43) Pub. Date: Aug. 20, 2015

(54) PORT ASSIGNMENT BASED ON DEVICE ORIENTATION

(71) Applicant: International Business Machines Corporation, Armonk, NY (US)

(72) Inventors: Shareef F. Alshinnawi, Apex, NC (US); Gary D. Cudak, Wake Forest, NC (US); Edward S. Suffern, Chapel Hill, NC (US); John M. Weber, Wake Forest, NC (US)

(73) Assignee: International Business Machines Corporation, Armonk, NY (US)

(21) Appl. No.: 14/182,072

(22) Filed: Feb. 17, 2014

(51) Int. Cl. H04L 12/24

(52) U.S. Cl. CPC H04L 41/0816; H04L 41/0806

(57) ABSTRACT

Embodiments of the present invention disclose a method, computer program product, and system for port assignment based on device orientation. In one embodiment, in accordance with the present invention, the computer implemented method includes the steps of determining a physical orientation of a computing device utilizing an orientation measurement device, wherein the computing device includes a plurality of ports on at least one face of the computing device, identifying a set of port numbering assignments that corresponds to the determined physical orientation of the computing device, modifying port numbering firmware of the computing device based on the identified set of port numbering assignments, and electronically displaying labeling corresponding to the plurality of ports on the face of the computing device based on the modified port numbering firmware and the identified set of port numbering assignments.

### BACKGROUND

The present invention relates generally to the field of device ports, and more particularly to port assignment based on device orientation. A network switch is a computer networking device that is used to connect a plurality of devices together on a computer network. Switches include advanced functionality compared to network hubs, because a switch transmits a message to the device for which the message is intended, rather than broadcasting the same message out each port of the switch. Network switches are prevalent in modern Ethernet local area networks (LANs), which can include many linked managed network switches.

Switches and other similar devices with faces that include cable ports often have many different types of ports on the device face (e.g., uplink ports, Ethernet ports, stacking ports, management ports, and other networking ports). The devices can be mounted in multiple different positions (i.e., horizontally or vertically), which leads to the orientation of ports on the face of the device to differ depending on the mounting position of the device.

### SUMMARY

Embodiments of the present invention disclose a method, computer program product, and system for port assignment based on device orientation. In one embodiment, in accordance with the present invention, the computer implemented method includes the steps of determining a physical orientation of a computing device utilizing an orientation measurement device, wherein the computing device includes a plurality of ports on at least one face of the computing device, identifying a set of port numbering assignments that corresponds to the determined physical orientation of the computing device, modifying port numbering firmware of the computing device based on the identified set of port numbering assignments, and electronically displaying labeling corresponding to the plurality of ports on the face of the computing device based on the modified port numbering firmware and the identified set of port numbering assignments.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for modifying and labeling port numbering assignments of a computing device, in accordance with an embodiment of the present invention.

FIG. 3 is a flowchart depicting operational steps of a program for mapping port numbering firmware of a computing device corresponding to port numbering assignments, in accordance with an embodiment of the present invention.

FIGS. 4A and 4B illustrate example port numbering on a faceplate of a computing device, in accordance with an embodiment of the present invention.

FIG. 5 depicts a block diagram of components of the computing system of FIG. 1 in accordance with an embodiment of the present invention.

### DETAILED DESCRIPTION

Embodiments of the present invention allow for modification of port numbering assignments of a device based on a determined orientation of the device. In one embodiment, the orientation of a device is determined, and a corresponding instance of port numbering assignments is identified. The port numbering assignments are utilized to modify the port numbering assignments of the device (e.g., in firmware of the device), and label the device ports.

Embodiments of the present invention recognize that devices with a port face that can be mounted in multiple different positions can introduce inconsistencies in port proximity and can create a non-normalized cabling structure. It can be beneficial to have cabling and port numbering schemes that are consistent throughout a datacenter. In other embodiments, a capability to modify the positioning of a switch can reduce cabling costs and complexity.

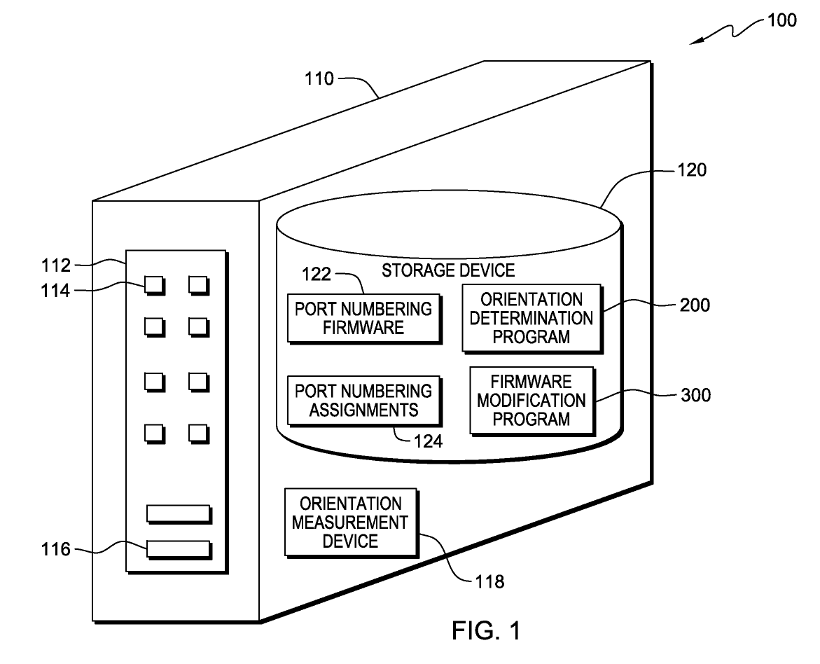

The present invention will now be described in detail with reference to the Figures. FIG. 1 is a functional block diagram illustrating a distributed data processing environment 100, in accordance with one embodiment of the present invention.

An embodiment of data processing environment 100 includes computing device 110. In various embodiments of the present invention, computing device 110 can be a network switch, or other types of devices that utilize ports (e.g., on the face of the device). For example, rack-mounted network switches include various ports on the face of the device, and can be mounted horizontally or vertically. The face of computing device 110 includes port numbering faceplate 112, which includes multiple instances of physical ports 114 and multiple instances of uplink ports 116. In example embodiments, physical ports 114 and uplink ports 116 can be representative of many different types of ports on the face of computing device 110 (e.g., uplink ports, Ethernet ports, stacking ports, management ports, and other networking ports). Computing device 110 can include any number and configuration of physical ports 114 and uplink ports 116, and is not limited to the depiction in FIG. 1. Port numbering faceplate 112 includes digital port numbering representations that correspond to physical ports 114 and uplink ports 116. The digital port numbering representations can be depicted utilizing simple numerical representations, or other representations of port enumeration. In example embodiments, port numbering faceplate 112 can utilize LED numbering, electronic ink, or other forms of visible digital numbering to depict the digital port numbering representations.

In one embodiment, computing device 110 includes orientation measurement device 118 and storage device 120. Orientation measurement device 118 is included within, or attached to computing device 110 and provides an indication of the orientation of computing device 110 (e.g., which side of computing device 110 is mounted facing downward, whether the device is mounted vertically of horizontally, etc.). In example embodiments, orientation measurement device 118 can be a gyroscopic sensor, accelerometer, tilt sensor, or any other device with the capability to determine the orientation of computing device 110. Storage device 120 can be implemented with any type of storage device, for example, persistent storage 508, which is capable of storing data that may be accessed and utilized by computing device 110, such as a database server, a hard disk drive, or flash memory. In other embodiments, storage device 120 can represent multiple storage devices within computing device 110.

Storage device 120 includes orientation determination program 200, firmware modification program 300, port numbering firmware 122, and port numbering assignments 124. In example embodiments, orientation determination program 200 modifies and labels port numbering assignments of computing device 110, in accordance with embodiments of the present invention. In example embodiments, firmware modification program 300 maps port numbering firmware 122 of computing device 110 corresponding to port numbering assignments 124, in accordance with embodiments of the present invention.

Port numbering firmware 122 is a portion of the firmware of computing device 110 that corresponds to the numbering of ports included within port numbering faceplate 112 (e.g., physical ports 114 and uplink ports 116). Firmware is the combination of persistent memory and program code, including stored data. For example, port numbering firmware 122 of computing device 110 associates each instance of physical port 114 with a corresponding numbering assignment (e.g., port number 1, 2, 3, etc.). Port numbering firmware 122 is capable of being modified (e.g., firmware flashing via firmware modification program 300) to alter the port numbering assignments of computing device 110.

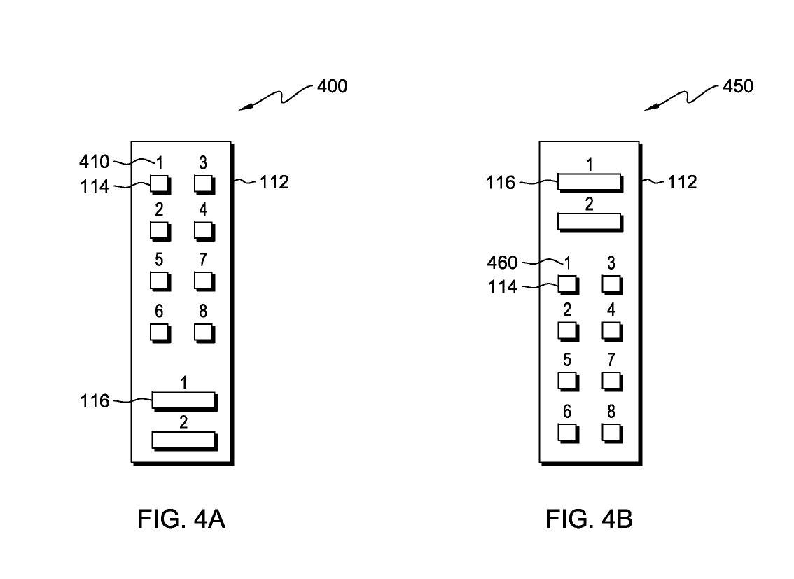

Port numbering assignments 124 are pre-defined numbering configurations of physical ports 114 and uplink ports 116 on the face of computing device 110 (e.g., ports within port numbering faceplate 112). An instance of port numbering assignments 124 can exist corresponding to each possible orientation of computing device 110 (e.g., vertically, horizontally, etc.). In one embodiment, a user of computing device 110 (e.g., a network administrator) manually sets instances of port numbering assignments 124 corresponding to each axis orientation, or combination of axis orientations of computing device 110. In an example, a user of computing device 110 manually defines an instance of port numbering assignments 124 for each vertical orientation of the face of computing device 110, which are depicted with regard to FIGS. 4A and 4B (i.e., example port numbering 400 and example port numbering 450). FIGS. 4A and 4B depict respective instances of physical ports 114 and uplink ports 116 included in port numbering faceplate 112. In this example, the user manually defines an instance of port numbering 410 for each instance of physical port 114 and uplink port 116 in example port numbering 400, and manually defines an instance of port numbering 460 for each instance of physical port 114 and uplink port 116 in example port numbering 450, both of which are stored as an instance of port numbering assignments and associated with the corresponding device orientation. In an example embodiment, port numbering faceplate 112 depicts the defined instance of port numbering (e.g., each instance of port numberings 410 and 460), and the port numbering is associated with port numbering firmware 122.

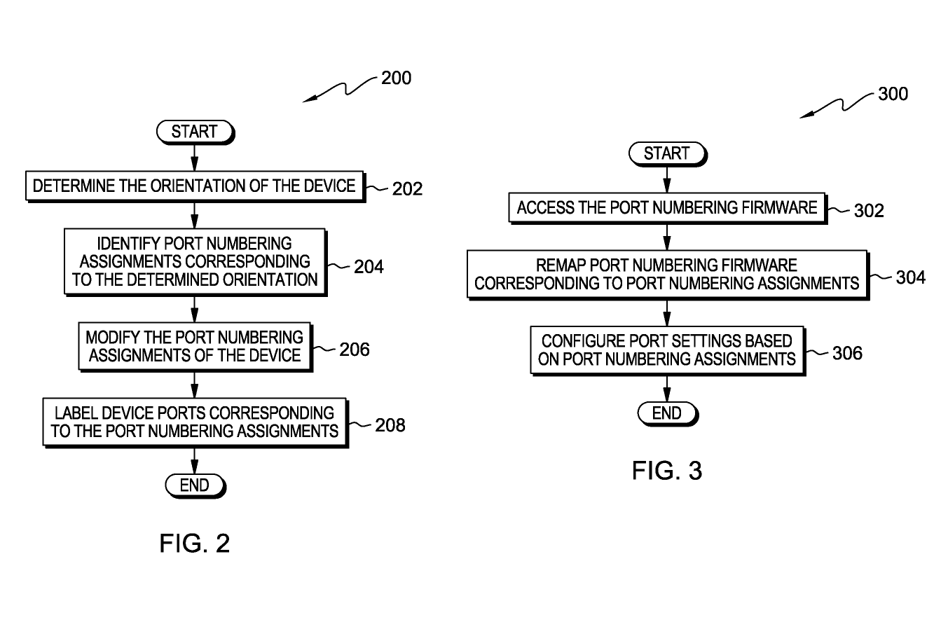

FIG. 2 is a flowchart depicting operational steps of orientation determination program 200 in accordance with an embodiment of the present invention. In example embodiments, orientation determination program 200 can initiate responsive to computing device 110 powering on, responsive to computing device 110 connecting to a system (e.g., a rack of network switches), or responsive to receiving an indication that the orientation of computing device 110 has changed (e.g., from orientation measurement device 118.) In other embodiments, computing device 110 can include an indication that the port numbering is to remain at a specified orientation regardless of the orientation of computing device 110. In these embodiments, orientation determination program 200 does not initiate automatically.

In step 202, orientation determination program 200 determines the orientation of the device. In one embodiment, orientation determination program 200 utilizes orientation measurement device 118 to determine the orientation of computing device 110. Orientation determination program 200 utilizes the orientation of computing device 110 to determine the corresponding configuration of physical ports 114 and uplink ports 116 on the face of computing device 110.

In step 204, orientation determination program 200 identifies port numbering assignments corresponding to the determined orientation. In one embodiment, orientation determination program 200 identifies an instance of port numbering assignments 124 in storage device 120 that corresponds to the orientation of computing device 110 (determined in 202). Port numbering assignments 124 are previously defined corresponding to various device orientations of computing device 110 (discussed previously with regard to FIG. 1). In one example with regard to example port numbering 400, orientation determination program 200 determines that the orientation of computing device 110 is vertical, with uplink ports 116 located at the bottom of port numbering faceplate 112 (in step 202). Then orientation determination program 200 identifies the instance of port numbering assignments 124 that corresponds to the determined orientation (i.e., of port numbering assignments that corresponds to the physical ports 114 and uplink ports 116 configuration depicted in FIG. 4A).

In step 206, orientation determination program 200 modifies the port numbering assignments of the device. In one embodiment, orientation determination program 200 modifies port numbering firmware 122 of computing device 110 (e.g., via flashing firmware) based on the determined orientation of computing device 110 (from step 202) and the identified corresponding instance of port numbering assignments 124 (from step 204). Modification of port numbering firmware 122 is discussed in greater detail with regard to FIG. 3.

In step 208, orientation determination program 200 labels device ports corresponding to the port numbering assignments. In one embodiment, orientation determination program 200 displays labeling on port numbering faceplate 112 corresponding to physical ports 114 and uplink ports 116 to reflect the current port numbering assignments (from step 206). In example embodiments, orientation determination program 200 labels physical ports 114 and uplink ports 116 corresponding to how the ports are perceived in port numbering firmware 122 (modified in step 206 and firmware modification program 300).

In the previously discussed example with regard to example port numbering 400, orientation determination program 200 determines that the orientation of computing device 110 is vertical, with uplink ports 116 located at the bottom of port numbering faceplate 112 (in step 202) and identifies the corresponding instance of port numbering assignments 124. Orientation determination program 200 utilizes the identified instance of port numbering assignments 124 to modify port numbering firmware 122 of computing device 110 (step 206). In this example, orientation determination program 200 labels physical ports 114 and uplink ports 116 in port numbering faceplate 112 utilizing port numbering 410, as depicted in FIG. 4A. In another example, where the determined orientation of computing device 110 is vertical, with uplink ports 116 located at the top of port numbering faceplate 112, orientation determination program 200 labels physical ports 114 and uplink ports 116 in port numbering faceplate 112 utilizing port numbering 460, as depicted in FIG. 4B (example port numbering 450).

FIG. 3 is a flowchart depicting operational steps of firmware modification program 300 in accordance with an embodiment of the present invention. In one embodiment, firmware modification program 300 initiates and operates in conjunction with step 206 of orientation determination program 200.

In step 302, firmware modification program 300 accesses the port numbering firmware. In one embodiment, firmware modification program 300 accesses port numbering firmware 122 of computing device 110, located on storage device 120. Port numbering firmware 122 is a portion of the firmware of computing device 110 that corresponds to the numbering of ports included within port numbering faceplate 112 (e.g., physical ports 114 and uplink ports 116).

In step 304, firmware modification program 300 remaps port numbering firmware corresponding to port numbering assignments. In one embodiment, firmware modification program 300 utilizes the instance of port numbering assignments 124 identified in step 204 of orientation determination program 200. Firmware modification program 300 remaps how physical ports 114 and uplink ports 116 are perceived in port numbering firmware 122 corresponding to the identified instance of port numbering assignments 124. In example embodiments, firmware modification program 300 utilizes firmware flashing to overwrite and remap an existing instance of port numbering firmware 122.

In step 306, firmware modification program 300 configures port settings based on port numbering assignments. In one embodiment, firmware modification program 300 utilizes the instance of port numbering assignments 124 identified in step 204 of orientation determination program 200, and configures the port settings corresponding to the remapping of port numbering firmware 122 (step 304). Responsive to remapping port numbering firmware 122, firmware modification program 300 also configures port settings to correspond to the remapped port numbering firmware 122 and port numbering assignments 124. In an example embodiment, responsive to a port numbering assignment changing from a first location on the face of computing device 110 to a second location on the face of computing device 110, mapping any corresponding port settings from the first location to the second location.

For example, in example port numbering 400, the instance of physical port 114 designated as port number 1 (in port numbering 410) has associated port settings in port numbering firmware 122. If the orientation of computing device 110 changes to the orientation depicted in example port numbering 450, then firmware modification program 300 will remap port numbering firmware 122 based on the instance of port numbering assignments 124 that corresponds to the orientation of computing device 110 (step 304). In this example, firmware modification program 300 configures the instance of physical port 114 designated as port number 1 (in port numbering 460 of example port numbering 450) to have the same associated port settings in port numbering firmware 122 that are associated with the instance of physical port 114 designated as port number 1 (in port numbering 410) in example port numbering 400.

In an example embodiment, port numbering firmware 122 corresponding to a port (e.g., physical port 114 and uplink port 116) can change the functionality of the port. For example, depending on physical orientation of computing device 110, an end point port, or a grouping of ports, can have certain associated port settings (e.g., an end point port may be perceived as a trunk port in port numbering firmware 122). In this example, depending on the physical orientation of computing device 110, firmware modification program 300 can configure the functionality of the end point port to be a trunk port (e.g., in port numbing firmware 122).

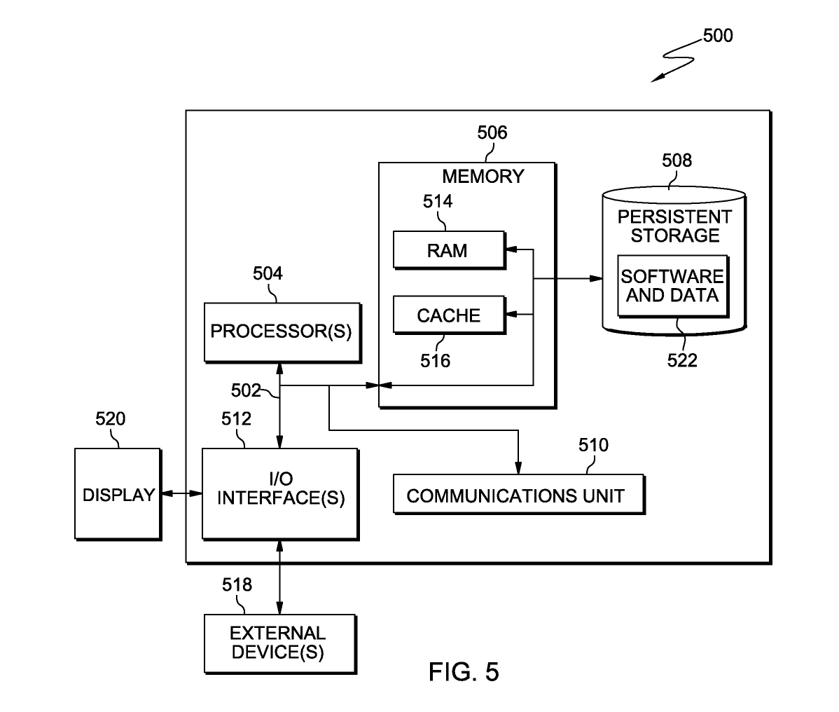

FIG. 5 depicts a block diagram of components of computer 500, which is representative of computing device 110 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are examples of computer readable tangible storage devices. A storage device is any piece of hardware that is capable of storing information, such as, data, program code in functional form, and/or other suitable information on a temporary basis and/or permanent basis. In this embodiment, memory 506 includes random access memory (RAM) 514 and cache memory 516. In general, memory 506 can include any suitable volatile or non-volatile computer readable storage device. Software and data 522 are stored in persistent storage 508 for access and/or execution by processors 504 via one or more memories of memory 506. With respect to computing device 110, software and data 522 represents orientation determination program 200, firmware modification program 300, port numbering firmware 122, and port numbering assignments 124.

In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 may include one or more network interface cards. Communications unit 510 may provide communications through the use of either or both physical and wireless communications links. Software and data 522 may be downloaded to persistent storage 508 through communications unit 510.

I/O interface(s) 512 allows for input and output of data with other devices that may be connected to computer 500. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data 522 can be stored on such portable computer readable storage media and can be loaded onto persistent storage 508 via I/O interface(s) 512. I/O interface(s) 512 also can connect to a display 520.

Display 520 provides a mechanism to display data to a user and may be, for example, a computer monitor. Display 520 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for port assignment based on device orientation, the method comprising the steps of:
determining a physical orientation of a computing device utilizing an orientation measurement device, wherein the computing device includes a plurality of ports on at least one face of the computing device;
identifying a set of port numbering assignments that corresponds to the determined physical orientation of the computing device;
modifying port numbering firmware of the computing device based on the identified set of port numbering assignments; and
electronically displaying labeling corresponding to the plurality of ports on the face of the computing device based on the modified port numbering firmware and the identified set of port numbering assignments.

2. The method in accordance with claim 1, wherein the step of determining the physical orientation of the computing device utilizing the orientation measurement device initiates responsive to one or more of: receiving an indication that the computing device is powering on, receiving an indication that the computing device is connecting to a system, and receiving an indication from the orientation measurement device that that the physical orientation of the computing device has changed.

3. The method in accordance with claim 1, wherein sets of port numbering assignments are pre-defined numbering configurations, based on physical orientations of the computing device, that correspond to the plurality of ports on the face of the computing device.

4. The method in accordance with claim 1, wherein the step of modifying port numbering firmware of the computing device based on the identified set of port numbering assignments further comprises the steps of:
mapping the port numbering firmware of the computing device based on the identified set of port numbering assignments; and
responsive to a port numbering assignment changing from a first location on the face of the computing device to a second location on the face of the computing device, mapping any corresponding port settings from the first location to the second location.

5. The method in accordance with claim 4, wherein the step of mapping the port numbering firmware of the computing device based on the identified set of port numbering assignments further comprises the step of:
flashing the port numbering firmware of the computing device.

6. The method in accordance with claim 1, wherein the labeling of the plurality of ports on the face of the computing device is electronically displayed as digital port numbering representations on a faceplate of the computing device.

7. The method in accordance with claim 1, wherein the computing device is a rack-mounted network switch.

8. The method in accordance with claim 1,
wherein the computing device includes the orientation measurement device, and
wherein the orientation measurement device is an accelerometer, a gyroscopic sensor, or a tilt sensor.

9. A computer program product for port assignment based on device orientation, including one or more computer readable storage media and program instructions stored on at least one of the one or more storage media, wherein execution of the program instructions by one or more processors of a computer system causes the one or more processors to carry out the acts of:
determining a physical orientation of a computing device utilizing an orientation measurement device, wherein the computing device includes a plurality of ports on at least one face of the computing device;
identifying a set of port numbering assignments that corresponds to the determined physical orientation of the computing device;
modifying port numbering firmware of the computing device based on the identified set of port numbering assignments; and
electronically displaying labeling corresponding to the plurality of ports on the face of the computing device based on the modified port numbering firmware and the identified set of port numbering assignments.

10. The computer program product in accordance with claim 9, wherein the program instructions for determining the physical orientation of the computing device utilizing the orientation measurement device initiates responsive to one or more of: receiving an indication that the computing device is powering on, receiving an indication that the computing device is connecting to a system, and receiving an indication from the orientation measurement device that that the physical orientation of the computing device has changed.

11. The computer program product in accordance with claim 9, wherein sets of port numbering assignments are pre-defined numbering configurations, based on physical orientations of the computing device, that correspond to the plurality of ports on the face of the computing device.

12. The computer program product in accordance with claim 9, wherein program instructions for modifying port numbering firmware of the computing device based on the identified set of port numbering assignments further comprises program instructions to carry out the additional acts of:
mapping the port numbering firmware of the computing device based on the identified set of port numbering assignments; and
responsive to a port numbering assignment changing from a first location on the face of the computing device to a second location on the face of the computing device, mapping any corresponding port settings from the first location to the second location.

13. The computer program product in accordance with claim 12, wherein program instructions for mapping the port numbering firmware of the computing device based on the identified set of port numbering assignments further comprises program instructions to carry out the additional acts of:
flashing the port numbering firmware of the computing device.

14. The computer program product in accordance with claim 9, wherein the labeling of the plurality of ports on the face of the computing device is electronically displayed as digital port numbering representations on a faceplate of the computing device.

15. A computer system for port assignment based on device orientation, the computer system comprising:
one or more computer processors;
one or more computer readable storage media; and
program instructions stored on the computer readable storage media for execution by at least one of the one or more processors, the program instructions comprising:
program instructions to determine a physical orientation of a computing device utilizing an orientation measurement device, wherein the computing device includes a plurality of ports on at least one face of the computing device;
program instructions to identify a set of port numbering assignments that corresponds to the determined physical orientation of the computing device;
program instructions to modify port numbering firmware of the computing device based on the identified set of port numbering assignments; and
program instructions to electronically display labeling corresponding to the plurality of ports on the face of the computing device based on the modified port numbering firmware and the identified set of port numbering assignments.

16. The computer system of claim 15, wherein program instructions to determine the physical orientation of the computing device utilizing the orientation measurement device initiates responsive to one or more of: receiving an indication that the computing device is powering on, receiving an indication that the computing device is connecting to a system, and receiving an indication from the orientation measurement device that that the physical orientation of the computing device has changed.

17. The computer system of claim 15, wherein sets of port numbering assignments are pre-defined numbering configurations, based on physical orientations of the computing device, that correspond to the plurality of ports on the face of the computing device.

18. The computer system of claim 15, wherein the program instructions to modify port numbering firmware of the computing device based on the identified set of port numbering assignments, further comprise program instructions to:
map the port numbering firmware of the computing device based on the identified set of port numbering assignments; and
responsive to a port numbering assignment changing from a first location on the face of the computing device to a second location on the face of the computing device, map any corresponding port settings from the first location to the second location.

19. The computer system of with claim 18, wherein the program instructions to map the port numbering firmware of the computing device based on the identified set of port numbering assignments, further comprise program instructions to:
flash the port numbering firmware of the computing device.

20. The computer system of claim 15, wherein the labeling of the plurality of ports on the face of the computing device is electronically displayed as digital port numbering representations on a faceplate of the computing device.
